(19) United States
(12) Patent Application Publication
(10) Pub. No.: US 2026/0244792 A1
(43) Pub. Date: Aug. 20, 2026

(54) METHODS AND SYSTEMS FOR GRANTING USERS ACCESS TO AMBIENT CONTROL SETTINGS IN A BUILDING ENVIRONMENT

(71) Applicant: Honeywell International Inc., Charlotte, NC (US)

(72) Inventor: Jayaprakash Meruva, Bangalore (IN)

(21) Appl. No.: 19/055,551

(22) Filed: Feb. 18, 2025

(51) Int. Cl. G06F 21/62; G07C 9/22

(52) U.S. Cl. CPC G06F 21/629; G07C 9/22; G06F 2221/2141

(57) ABSTRACT

A method for granting users access to ambient control settings in a building environment is disclosed. The method comprises transmitting, by a user device to an access control system, an ambient control access request to seek access to one or more ambient control settings associated with a location of the user device. The access request comprises the location of the user device and a user ID. The method further comprises receiving, by the access control system, the ambient control access request from the user device and determining whether the user is permitted access to a space corresponding to the location of the user device based on the location, the user ID, and an access control database. The method further includes transmitting, by the access control system, an access response to the user device. The method further comprises granting or denying permission to access the one or more ambient control settings.

### TECHNICAL FIELD OF THE INVENTION

The present subject matter relates to control management systems in building environments and, more particularly, to systems and methods for granting users access to ambient control settings in a building environment.

### BACKGROUND OF THE INVENTION

Modern commercial buildings and office spaces increasingly incorporate advanced technologies to enhance occupant comfort and convenience. One such innovation is the ability to control building ambience, such as lighting, temperature, and other environmental parameters, through mobile applications. These apps, when installed on user devices like smartphones or tablets, allow users to adjust various settings to suit their preferences. For instance, a user in a conference room may use the app to dim the lights or lower the room temperature with just a few taps.

While app-based control systems offer convenience and flexibility, they often lack adequate mechanisms to regulate access. In many cases, these systems grant control privileges to any individual with the app installed on their device, provided they are within the operational range of the system. While this broad accessibility might be acceptable in certain scenarios, it poses challenges in environments where more stringent control is necessary.

One significant limitation of such systems is their reliance on a user's current location to determine access. For example, existing systems often use indoor positioning techniques to identify the user's proximity to specific zones, rooms, or equipment within the building. Based on this location information, users are permitted to control the ambience of the associated area. However, this approach does not take into account the user's role, designation, or authorization level, potentially leading to unintended access.

Consider a situation where a visitor or non-authorized employee is in the vicinity of an executive office or a restricted area. Using the app, the individual could inadvertently or intentionally gain control over sensitive settings such as the lighting or temperature in that space. This lack of control over who can access and modify the building's environmental settings can lead to privacy concerns, operational inefficiencies, and even security risks.

Furthermore, the absence of user-specific restrictions can create disruptions in shared spaces. For example, in a shared office environment, multiple users might simultaneously attempt to adjust the settings of the same space, leading to conflicting inputs and potential dissatisfaction among occupants. Such scenarios highlight the need for access control systems that not only account for the user's location but also incorporate additional parameters to ensure that only authorized individuals can modify specific settings.

Current systems also fail to address scenarios where user roles vary significantly. For instance, administrators, employees, and visitors may each require different levels of access to building controls. A universal approach that permits control based solely on location does not cater to these distinctions, resulting in a one-size-fits-all solution that is often unsuitable for diverse organizational needs. Consequently, there is a pressing need to explore methods that can provide a more secure and role-aware access mechanism while maintaining the flexibility and ease of use that app-based systems offer.

### SUMMARY OF THE INVENTION

The widespread adoption of app-based systems for controlling building ambience, such as lighting and temperature, presents significant challenges due to their broad and indiscriminate access mechanisms. Current systems often rely solely on a user's location to grant control, disregarding the user's role, designation, or authorization level. This can lead to unauthorized individuals, such as visitors or non-authorized employees, gaining control over sensitive or restricted areas, such as executive offices, simply because they are nearby. Additionally, the lack of user-specific restrictions can cause conflicts in shared spaces and fails to accommodate varying access needs for different user roles, resulting in privacy concerns, operational inefficiencies, and security risks.

The present subject matter discloses methods and systems for granting users access to ambient control settings in a building environment based on physical access control system policies defined in the building for users.

In an embodiment, a method for granting users access to ambient control settings in a building environment is disclosed. The method comprises transmitting, by a user device to an access control system, an ambient control access request to seek access to one or more ambient control settings associated with a location of the user device. The access request comprises the location of the user device and a user ID associated with a user of the user device. The method further comprises receiving, by the access control system, the ambient control access request from the user device and determining whether the user is permitted access to a space corresponding to the location of the user device. This determination is based on the location, the user ID, and an access control database communicatively coupled to the access control system. The access control database contains information about a plurality of spaces in the building and details about users authorized to access these spaces. The method further includes transmitting, by the access control system, an access response to the user device. Based on the access response, the user device either grants or denies permission to access the one or more ambient control settings associated with its location.

In an embodiment, the method further comprises displaying, by the user device, one or more ambient control settings associated with the location of the user device, when the access response indicates that the user is permitted access to the space corresponding to the location of the user device.

In an embodiment, the method further comprises receiving, by the user device, a user input for adjusting at least one ambient control setting from the one or more ambient control settings displayed to the user. The method also includes transmitting, by the user device, a control request to a building management system for implementing the adjusted ambient control setting.

In an embodiment, the method further comprises displaying, by the user device, an error message when the access response indicates that the user is not permitted access to the space corresponding to the location of the user device.

In an embodiment, the method further comprises assigning, by the access control system, one or more doors to at least one space in the plurality of spaces associated with the building based on a first admin input. The method also includes mapping at least one user ID to the one or more doors based on a second admin input.

In an embodiment, the method further comprises determining, by the user device, the location of the user device using at least one of an indoor location determination technique or a GPS technique.

In an embodiment, the method further comprises configuring the access control system as one of a cloud-based access control system or an on-premise access control system.

In another embodiment, a system for granting users access to ambient control settings in a building environment is disclosed. The system comprises a user device and an access control system communicatively coupled to the user device. The user device is configured to transmit an ambient control access request to the access control system, seeking access to one or more ambient control settings associated with the location of the user device. The access request comprises the location of the user device and a user ID associated with the user. The user device is further configured to grant permission to access the one or more ambient control settings based on an access response received from the access control system. The access control system is configured to receive the ambient control access request from the user device, determine whether the user is permitted access to a space corresponding to the user device's location using an access control database, and transmit an access response to the user device. The access control database stores information about multiple spaces in the building and details of users permitted to access these spaces.

In yet another embodiment, a computer-readable medium having computer-executable instructions stored thereon is disclosed. When executed by a processing unit, the instructions cause the processing unit to execute a method for granting users access to ambient control settings in a building environment. The method comprises transmitting an ambient control access request to an access control system to seek access to one or more ambient control settings associated with a location of a user device, wherein the access request comprises the location of the user device and a user ID associated with a user of the user device. The method further includes receiving the ambient control access request from the user device, determining whether the user is permitted access to a space corresponding to the location of the user device using an access control database, and transmitting an access response to the user device. The method further comprises granting permission to access the one or more ambient control settings associated with the location of the user device based on the access response. The access control database includes information about a plurality of spaces in the building and the users authorized to access these spaces.

The present subject matter provides an efficient and secure method and system for granting users access to ambient control settings in a building environment. For instance, according to aspects of the present subject matter as described herein, the already defined user permissions corresponding to users are leveraged in determining whether or not to provide users with access to ambient control settings in a space of a floor in the building. Thus, the need to define separate permissions for ambient control settings access management is averted, helping in reducing the resources involved therewith.

### BRIEF DESCRIPTION OF DRAWINGS

Embodiments of the subject matter will hereinafter be described in conjunction with the following drawing figures, wherein like numerals denote like elements, and:

FIG. 1 illustrates an environment implementing a system for granting users access to ambient control settings in a building environment, according to one or more embodiments of the present subject matter;

FIG. 2 illustrates a schematic diagram of the system, according to one or more embodiments of the present subject matter;

FIG. 3 illustrates a schematic diagram explaining the operations of the system, according to one or more embodiments of the present subject matter;

FIG. 4 illustrates a schematic diagram explaining the operations of the system, according to one or more embodiments of the present subject matter;

FIG. 5 illustrates a flowchart of a method for granting users access to ambient control settings in a building environment, according to one or more embodiments of the present disclosure;

FIG. 6 illustrates a flowchart of a method for adjusting ambient control settings in a building environment, according to one or more embodiments of the present disclosure;

FIG. 7 illustrates a flowchart of a method for assigning doors to spaces and mapping user access in a building environment, according to one or more embodiments of the present disclosure; and

FIG. 8 illustrates a computer system, according to one or more embodiments of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF INVENTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

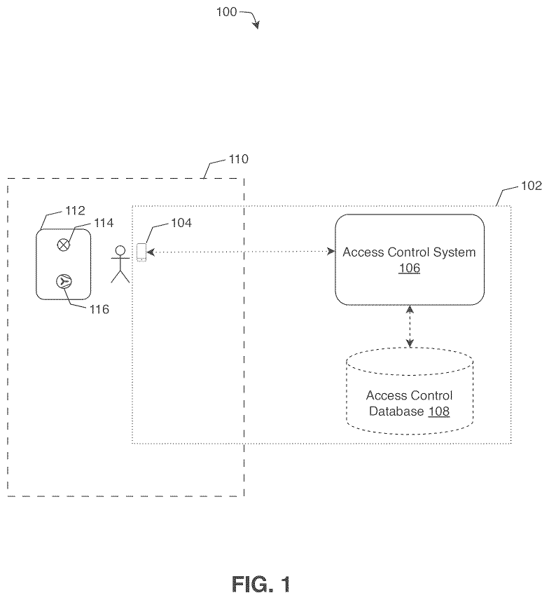

FIG. 1 illustrates an environment 100 implementing a system 102 for granting users access to ambient control settings in a building environment, according to one or more embodiments of the present subject matter. The users may be understood as occupants of a building. For instance, the users may be employees of a company or guest visitors visiting the company office which is situated on a floor/across one or more floors in the building. The ambient control settings may be understood as control settings of one or more lighting or operational elements which are present in an ambient space, for example, a room or a section of the floor, to the user. For instance, the user may be near a conference room or inside a conference room. Herein, the ambient control settings may be understood as control settings relating to one or more lights, fans, air conditioning unit, monitor, etc, installed in the conference room. Furthermore, in some examples, the ambient control settings may be understood as control settings related to one or more devices present in the ambient location of the user. For instance, when the user is in the conference room, besides the lighting, heating/cooling controls, the ambient control settings may also relate to devices, such as a printer, a TV, a conferencing unit, an audio device, a coffee dispenser, etc. present in the room. Likewise, when the user is in a pantry area, besides the lighting, heating/cooling controls, the ambient control settings may also relate to devices, such as a coffee dispenser, a snack dispenser, a TV, a sound device, etc. present in the pantry area. Thus, in essence, the ambient control settings may relate to HVAC related components and devices present in the location where the user is present.

The system 102 may include, without limitation, a user device 104, an access control system 106 (“the system 106”), and an access control database 108 (“the database 108”) which may be implemented as part of the system 106 or separate therefrom. Examples of the user device 104 may include, a smartphone, a tablet, a personal digital assistant, a laptop, and the like. The system 106 may be a cloud-based access control system, in an example implementation. Furthermore, the environment 100 shown herein depicts an example floor 110 of a building, a room 112 on the floor 110, and an example light 114 and an example fan 116 provided in the room 112. As may be understood, the floor 110 may include further rooms similar to the room 112 and/or designated sections or zones, such as a break room. Each of the rooms, including the room 112, and the sections or zones may include further lights, fans, other operational elements as required. However, for the sake of brevity, only one fan and one light are shown in the room 112.

In an example, a user may be present in the room 112 and may seek to switch on/off the light 114 and/or the fan 116 present in the room 112. For the aforementioned desired operations, the user may open an application, such as an office application or a building management application, on the user device 104 and may log in to the same. Once logged in, the user may explore one or more menu options associated with accessing the ambient control settings and raise a request for accessing the ambient control settings. Accordingly, in some example embodiments, the user device 104 may be configured to transmit an ambient control access request to the system 106 for seeking access to the one or more ambient control settings associated with the room 112. The ambient control access request may include the location of the room 112 and the user id of the user, in an example.

On receiving the ambient control access request, the system 106 may be configured to determine whether the user is permitted access to a space corresponding to the location of the user device 104. In some embodiments, the system 106 may make the aforesaid determination based on the location, the user id, and the database 108. The database 108 may include information about a plurality of spaces present in the building and information about a plurality of users who are permitted access to the plurality of spaces. For instance, the database 108 may include a plurality of location coordinates of the floor 110, names of spaces, such as room A, room B, cafeteria, break room, etc., corresponding to the location coordinates, and details of one or more user ids mapped to the plurality of spaces.

In the aforementioned example, the space corresponding to the location received in the ambient control access request is the room 112. Thus, the system 106 may determine whether the user is permitted access to the room 112 or not. For making the determination, the system 106 may query the database 108, for example, using the user id of the user and the location of the user device 104. The database 108 may process the query and accordingly generates a query response for transmitting to the system 106. In the query processing, the database 108 ascertains the name of the space corresponding to the received location. Thereafter, the database 108 may ascertain whether the user id is mapped to the ascertained space or not. In case the user is permitted to access the room 112, the user id of the user is found to be mapped to the room 112 in the database 108. In case the user is not permitted to access the room 112, the user id of the user is not found to be mapped to the room 112 in the database 108. Accordingly, the database 108 generates the query response.

The generated query response includes the name of the space, i.e., the room 112 in this case, and may further include information to indicate whether or not the user is permitted access to the room 112 based on whether or not the user id is found to be mapped in the database 108. The information indicates that the user is permitted to access the room 112 in case the user id is found to be mapped to the room 112. In the other case, the information indicates that the user is not permitted to access the room 112 when the user id is not found to be mapped to the room 112. The database 108 transmits the generated query response to the system 106.

On receiving the query response, the system 106 transmits an access response to the user device 104. The access response, amongst other things, may include the information received in the query response which indicates whether or not the user is permitted access to the room 112. In case the user is not permitted access to the room 112, the user device 104 does not grant permission to the user to access the one or more ambient control settings. In the alternate, in case the user is permitted access to the room 112, the user device 104 grants permission to access the one or more ambient control settings associated with the room 112. For instance, the user device 104 may permit the user to access a section of the application which was previously locked, and which includes a listing the one or more ambient control settings.

After gaining access to the listing, the user may accordingly provide a user input to switch on/off the light 114 or control its operation, for example, dim the light, as required. Based on the user input thus received, the user device 104 may communicate with an on-premise building management system (BMS), either directly or through a cloud BMS, to change the operation of the light 114 based on the user input.

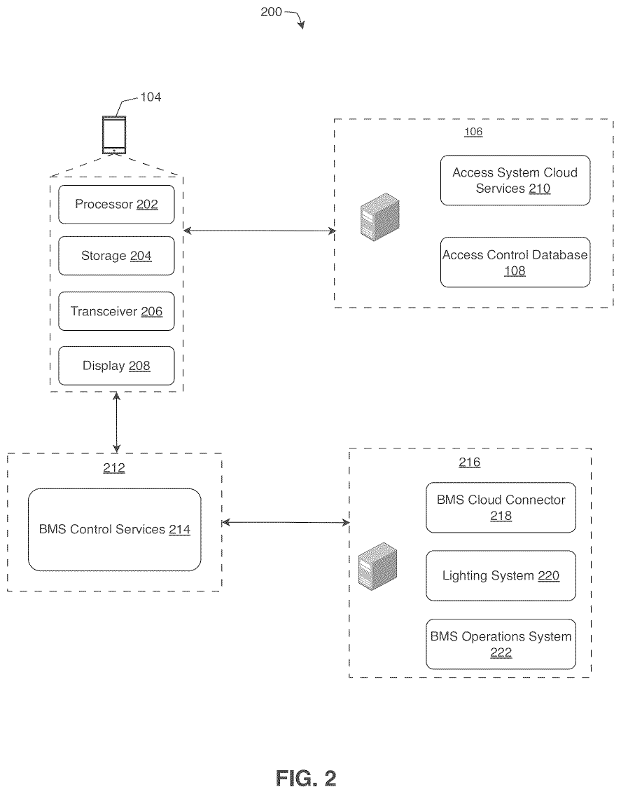

FIG. 2 illustrates a schematic diagram 200 of the system 102 according to one or more embodiments of the present subject matter. As shown the figure, the diagram 200 depicts the user device 104, the system 106, a Building Management System (BMS) cloud 212, and an on-premise BMS 216.

The user device 104 may include a processor 202, storage 204, a transceiver 206, and a display 208. The processor 202, in some examples, may be implemented or realized as general-purpose processors, a content addressable memory, a digital signal processor, an application specific integrated circuit, a field programmable gate array, any suitable programmable logic device, discrete gate or transistor logic, discrete hardware components, or any combination designed to perform the functions described here. In some examples, the processor 202 may be realized as microprocessors, controllers, microcontrollers, or state machines. In some examples, the processor 202 may be realized as a combination of computing devices, such as, a combination of digital signal processors and microprocessors, a plurality of microprocessors, one or more microprocessors in conjunction with a digital signal processor core, or any other such combination/configuration.

The storage 204 comprises one or more non-transitory computer-readable storage media, including but not limited to volatile storage media such as random-access memory (RAM), registers, cache, etc., as well as non-volatile storage media such as read-only memory (ROM), hard disk drives, solid-state drives, flash memory, optical storage devices, and so forth. Furthermore, the storage 204 may encompass computer-readable storage media that are distributed across a plurality of physical computing devices connected via a network, such as storage clusters within public, private, or hybrid cloud-based environments. In some embodiments, the storage 204 may be provisioned with software components that facilitate the system 102 in executing functionalities disclosed herein. These software components typically consist of program instructions executable by the processor 202, organized into software applications, virtual machines, software development kits, toolsets, or similar structures. Furthermore, the storage 204 may be configured to maintain data within one or more databases, file systems, or equivalent data structures.

In some example embodiments, the user device 104 may be used by a user to seek access to ambient control settings pertaining to one or more electrical elements, such as a light or a fan, and one or more operations elements, such as air conditioning, present in an ambient space of the user. Furthermore, in some examples, the ambient control settings may be understood as control settings related to one or more devices present in the ambient location of the user. For instance, when the user is in the conference room, besides the lighting, heating/cooling controls, the ambient control settings may also relate to devices, such as a printer, a TV, a conferencing unit, an audio device, a coffee dispenser, etc. present in the room. Likewise, when the user is in a pantry area, besides the lighting, heating/cooling controls, the ambient control settings may also relate to devices, such as a coffee dispenser, a snack dispenser, a TV, a sound device, etc. present in the pantry area. Thus, in essence, the ambient control settings may relate to HVAC related components and devices present in the location where the user is present.

The user may seek access to these control settings via an application running on the user device 104. In some examples, the application may be a dedicated application managed by an organization of the user or by an owner of the building. In some examples, the application may be a browser application of the user device 104 via which a website relating to building management operations may be accessed. Amongst other things, the website/application may provide the user with access to control settings pertaining to the electrical and operational elements installed in various rooms or sections on the floor, post validation of the user's access rights to the rooms/sections according to aspects of the present subject matter.

As may be understood, on opening the application or the website, the user may be required to log in to the application/website. In case the user is an employee of the organization, the user may perform the log in using corresponding user id and password set during the registration of the user's user account with the organization. In another case where the user is a guest, the user may perform the log in using a temporary guest user id and password issued to the user.

Once the user has logged in, the user may navigate the application/website to locate the option for accessing the ambient control settings corresponding to the one or more electrical or operational elements present in the ambient surroundings of the user. The user may accordingly select the option to gain access to the ambient control settings, post which the validation of the user's access rights may be performed accordingly to the aspects of the present subject matter and accordingly, the user may or may not be provided access to the ambient control settings.

The system 106 may include one or more access system cloud services 210 (“the services 210”) and the database 108. The services 210 may be configured to handle, amongst other things, access requests relating to ambient control settings. For instance, the services 210 may receive the incoming access requests from the user devices 104 and may forward the same to a processing block (not shown in the figure) in the system 106 for processing of the requests using the records stored in the database 108. The database 108, as explained above in the description of FIG. 1, includes a plurality of records. Each of these records may include a set of location coordinates, a name of a room/space on the floor corresponding to the set of location coordinates, one or more user ids which are permitted to access the room/space, and optionally a time period for which the user ids may be allowed to access the room/space. In an example implementation and without limitation, the system 106 may be implemented by the organization.

The BMS cloud 212, amongst other things, may include one or more BMS control services 214. The on-premise BMS 216 may include a BMS cloud connector 218, a lighting system 220, and a BMS operations system 222. The BMS cloud 212 may be configured to receive requests relating to controlling the operations of the electrical and operational elements in the building. These requests may be received from the user devices 104, in an example. At the BMS cloud 212, the control services 214 handles the requests and forwards them to the appropriate system in the on-premise BMS 216. For instance, a request relating to controlling of a light may be forwarded to the lighting system 220 in the on-premise BMS 216. Similarly, a request relating to controlling of the air conditioning may be forwarded to the BMS operations system 222 in the on-premise BMS 216. In the on-premise BMS 216, the BMS cloud connector facilitates communication between the BMS cloud 212 and the components of the on-premise BMS 216.

As mentioned earlier, the user may use the user device 104 to seek access to the ambient control settings relating to one or more electrical and/or operational elements present in ambient space to the user. For example, the user may be in a conference room and may wish to switch on/off one or more lights in the conference room. Accordingly, the user may seek access to the ambient control settings related to the lights in the conference room. For seeking the access to the ambient control settings, in an example, the user may open the application on the user device 104 and may explore one or more menu options related to the ambient control settings. On identifying a menu option which corresponds to ambient control settings, the user may make a user selection of the said option, for instance, through a touch input or a voice input.

On receiving the selection of the option corresponding to the ambient control settings in the application, the user device 104 may be configured to ascertain as to whether the user is permitted access to a location where the user is present or not. Accordingly, based on the result of the ascertaining, the user device 104 may present the user with access to one or more ambient control settings corresponding to the one or more electrical/operational elements present in the location. For instance, on a positive ascertaining, i.e., on finding that the user is permitted access to the location, the user device 104 may permit the user to access the one or more ambient control settings. In another case where a negative ascertaining is made, i.e., on finding that the user is not permitted access to the location, the user device 104 may not permit the user to access the one or more ambient control settings.

In an embodiment, for making the aforementioned ascertaining, the user device 104 may be configured to generate and transmit an ambient control access request to the system 106. As mentioned earlier in the description of FIG. 1, the ambient control access request may include a location of the user device 104 and a user id of the user.

In an embodiment, one or more walls of the floor of the building where the user device 104 is present may be equipped with wireless beacons (not shown in the figure). As may be understood, the beacons may emit signals that may be detected by the user device 104. In an example, the processor 202 may process the signal strengths and time delays from a plurality of beacons using triangulation techniques to calculate the geographical coordinates corresponding to the user device 104. The processor 202 may thereafter resolve the geographical coordinates to a specific area, space, or room on the floor. For instance, the calculated location may indicate that the user device 104 is situated in a conference room, an open workspace, or any designated section of the floor. Thus, in an implementation, the user device 104 may determine the location of the user device 104 using the beacons, if available.

In an embodiment, the user device 104 may determine its position on the floor of the building using Wi-Fi signals. Herein, in a first example, the processor 202 may actively scan for one or more Wi-Fi access points within the user device 104's range and collect information, such as the signal strength (RSSI) and unique identifiers (e.g., MAC addresses) of the aforementioned access points. The processor 202 may subsequently communicate with the access system 106 to obtain a pre-existing Wi-Fi fingerprint map of the building, which associates specific Wi-Fi signal patterns with precise locations on the floor. In an example, the processor 202 may use the Wi-Fi fingerprint map to compare its scanned data against the stored patterns and accordingly determine its location. For instance, the processor 202 may apply one or more algorithms, such as triangulation, trilateration, or signal pattern matching to compute its location based on the Wi-Fi fingerprint map and the scanned data collected by the processor 202. In some examples, the computed location may be refined by the processor 202 using additional sensor data from the sensors of the user device 104, such as accelerometer or gyroscope readings.

In a second example, the processor 202 may perform the initial scan of the Wi-Fi signals as explained above in the first example and transmit the collected data, including signal strength and access point identifiers to the access system 106. In this example, the access system 106 which has the Wi-Fi fingerprint map of the building in a storage communicatively coupled therewith, may process the received data and accordingly determine the precise location of the user device 104. For instance, the system 106 may compare the signal data included in the received information with the map and apply one or more localization algorithms. Once the access system 106 identifies the user device 104′s position based on the aforementioned processing, the access system 106 may send the computed location information back to the user device 104. Thus, in the described example, the user device 104 may determine the location using the system 106.

In yet another example embodiment, the processor 202 may be configured to implement GPS positioning technique to determine the location of the user device 104, for instance, when the user device 104 may have GPS capabilities. Herein, the processor 202 may make use of a GPS unit (not shown in the figure) provided in the user device 104 and using known GPS techniques, the processor 202 may determine the location of the user device 104. Furthermore, in some example embodiments, the processor 202 may also implement an indoor positioning technique such as those described above along with the GPS positioning techniques to determine the location of the user device 104 in the building.

Once the processor 202 determines the location, the processor 202 may generate the ambient control access request which includes the location of the user device 104 and the user id of the user with which the user has logged into the application. In an example, the location of the user device 104 may include the location coordinates and/or name of the room/space where the user device 104 is present. Referring to the user id, in an example, where the user is an employee of the organization, the user id may be an id created during the registration of the user with the organization. In another example, where the user is a guest visitor, the user id may be a temporary guest id. After generating the ambient control access request, the processor 202 may transmit the ambient control access request to the system 106 using the transceiver 206.

At the system 106, the services 210 may receive the ambient control access request, in an example. The services 210 may subsequently query the database 108 based on the data received in the ambient control access request. That is, the services 210 may query the database 108 based on the location of the user device 104 and the user id. In an example, the services 210 may access the database 108 and scan through the records to identify a record which includes a set of location coordinates or name of a room which matches with the location of the user device 104. On identifying such a record, the services 210 may be configured to ascertain whether the user id of the user is found in this record. As mentioned above, the database 108 includes a plurality of record and each of the records may include, a set of location coordinates, a name of the room/space to which the set of location coordinates correspond, one or more user ids which are permitted access to the room/space, and other information.

Based on the result of the ascertaining, the services 210 accordingly generates an access response. In case the services 210 ascertain that the record includes the user id, the access response includes an indication that the user device 104 is permitted access to the room/space/corresponding to the location of the user device 104. In another case where the services 210 ascertains that the record does not include the user id, the access response includes an indication that the user device 104 is not permitted access to the room/space/corresponding to the location of the user device 104. The services 210 transmits the generated access response to the user device 104.

In an example, the processor 202 may process the access response received from the system 106 using the transceiver 206. Based on the access response, the processor 202 may grant permission to access the ambient control settings associated with the location of the user device 104. For instance, when the access response indicates that the user device 104 is not permitted access to the room/space corresponding to the location of the user device 104, the processor 202 may be configured to deny the user permission to access the one or more ambient control settings. In this case, the processor 202 may be configured to display an error message on a graphical user interface of the application, in response to the user's selection of the menu option corresponding to the ambient control settings. In some examples, the error message may indicate that the user is not permitted to access the location. In some examples, the error message may indicate a contact of another user, like a helpdesk id, which may be contacted for setting the ambient control settings.

Alternatively, when the access response indicates that the user device 104 is permitted access to the room/space corresponding to the location of the user device 104, the processor 202 may be configured to grant the user permission to access the one or more ambient control settings. Accordingly, the processor 202 may display a graphical user interface of the application which includes the one or more ambient control settings.

As would be appreciated, in some embodiments, the user may access a website using a browser application on the user device 104 for seeking access to the one or more ambient control settings. Accordingly, the GUI including the one or more ambient control settings or the GUI including the error message may be a GUI of a website displaying the aforementioned.

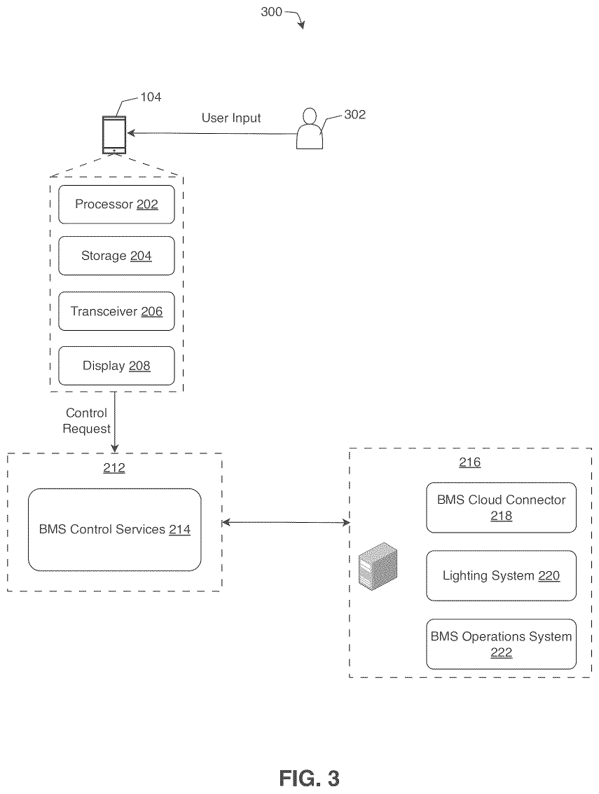

In some embodiments, on being presented with the GUI including the one or more ambient control settings, the user may select an ambient control setting corresponding to the electrical/operational component present in the room, as desired. Subsequently, the user may present a user input for altering the selected ambient control setting, as is explained in detail in FIG. 3 description below.

FIG. 3 depicts a schematic diagram 300 illustrating the operations of the system 102, according to one or more embodiments of the present subject matter. In the diagram 300, the user device 104, the BMS cloud 212, the on-premise BMS 216, and a user 302 is shown. In an example, the user 302 may be an employee of the organization implementing or availing the services of the system 102. In another example, the user 302 may be a visitor to an office of the organization.

In an example, the user 302 may seek to access the one or more ambient control settings pertaining to electrical/operational elements present in a space/room in which the user 302 is present. According to embodiments of the present subject matter, the user 302 may be provided with access to the one or more ambient control settings based on space/room related user access permissions for the user id of the user 302, as explained in the detailed description above.

In some example embodiments, where the user 302 is permitted access to the one or more ambient control settings, the user may provide a user input for adjusting at least one ambient control setting. For instance, the user may be in a conference room and may seek to switch off a fan located above him. In this case, on being presented with the GUI including the one or more ambient control settings, the user may proceed to select the ambient control setting corresponding to the aforementioned fan and may provide a user input to turn it off.

On receiving the user input, the processor 202 may be configured to perform actions for realizing the change in the operation state of the electrical/operational element, as desired by the user 302. To this end, the processor 202 may be configured to generate and transmit, a control request to the on-premise 216 via the BMS cloud 212. In an example, the control request may include an identifier of the electrical/operational element and information about a new state which is desired for the electrical/operational element by the user 302. For instance, the user 302 may seek to turn off the fan as mentioned above in the example. Accordingly, the new state for the fan would be “off ”. Thus, in said case, the control request may include the identifier of the fan and the new state, i.e., “off”. In some cases, the new state may indicate a speed of the fan in case the user 302 wishes to change the speed of the fan.

In an example, the processor 202 may transmit the generated control request to the BMS cloud 212. At the BMS cloud 212, the BMS control services 214 or the services 214 may receive and process the control request. In an example, the services 214 may process the control request to identify an end system to which the control request relates to. Accordingly, the services 214 may forward the control request to the concerned end system. For instance, in the above example, as the control request relates to electrical element, i.e., fan, the services 214 may identify that the control request relates to the BMS operations system 222.

On identifying the end system, in an example, the services 214 may transmit the control request to the particular end system in the on-premise BMS 216. In said example, the services 214 may either modify the control request or may encapsulate it in another request to include an identifier of the end system. In the above example of the fan, the services 214 may include an identifier, such as an IP address of the BMS operations system 222, in the control request and transmit the same to the on-premise BMS 216.

At the on-premise BMS 216, the BMS cloud connector 218 may receive the control request and process the same for forwarding it to the appropriate end system. In the above example, the BMS cloud connector 218 may process the received control request and determine that the control request is addressed to the BMS operations system 222. Accordingly, the BMS cloud connector 218 forwards the control request to the BMS operations system 222 for further processing. The BMS cloud connector 218, on receiving the control request, may process the identifier and the new state/speed of the fan and accordingly control the fan as desired by the user 302.

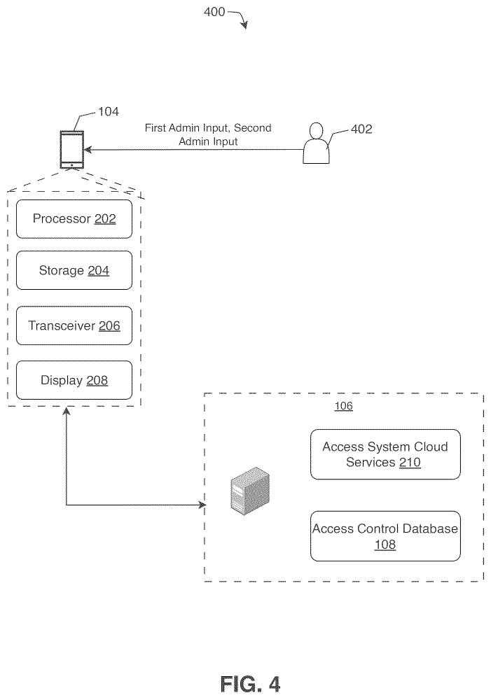

FIG. 4 depicts a schematic diagram 400 illustrating the operations of the system 102, according to one or more embodiments of the present subject matter. In the diagram 400, the user device 104, the system 106, and a user 402 is shown. In an example, the user 402 may be an employee of the organization implementing or availing the services of the system 102. In some examples, the user 402 may be having the role of an administrator and may be entrusted with marking spaces, such as open spaces, on a floor of an office of the organization in the building.

As may be understood, besides having conventional cabins and rooms, a floor of a building may also include one or more open spaces. These open spaces may be, for example, a cafeteria, a printer section, an open seating section, etc. In some examples, the user 402 may seek to virtually demarcate the open spaces, for example, in a digital map for the purposes of controlling building elements, such as lights, fans, etc., therein.

According to an embodiment of the present subject matter, the user 402 may explore the application/website and may access a menu option which provides a digital map of the floor on a display of the user device 104 or a connected display of the user device 104. In an embodiment, on being presented with the map, the user 402 may use one or more app tools to demarcate one or more spaces on the digital map of the floor. As may be understood, on demarcation, the one or more spaces may be assigned and identified with a unique identifier.

Once the one or more spaces are demarcated, in some embodiments, the system 102 may permit the user 402 to assign one or more doors to at least one space on the floor using the application/website on the user device 104. For instance, the system 102 may provide one or more menu options in the application/website for adding the one or more doors to the demarcated space. Herein, the user may provide a first admin input by selecting the menu option to add the doors to the room. On addition of the one or more doors, the system 102 permits the user to add one or more user ids corresponding to the demarcated space in the access control database 108. In other words, on the demarcation and addition of the doors to a space, a record corresponding to the space is created in the access control database 108 where the admin can subsequently add the user ids, for example, through a second admin input.

Referring to an example use case, a user, say, a guest present in one of the open spaces on the floor may seek access to ambient control settings corresponding to electrical/operational elements around them. Herein, the request may be routed to the database 108 as explained in the description earlier. In case the guest id is found mapped to the open space, the guest is permitted access to the ambient control settings and the guest can change the electrical/operational component in the open space. In another case, where the guest id is not found mapped to the open space, the guest is not permitted access to the ambient control settings and the guest cannot change the electrical/operational component in the open space.

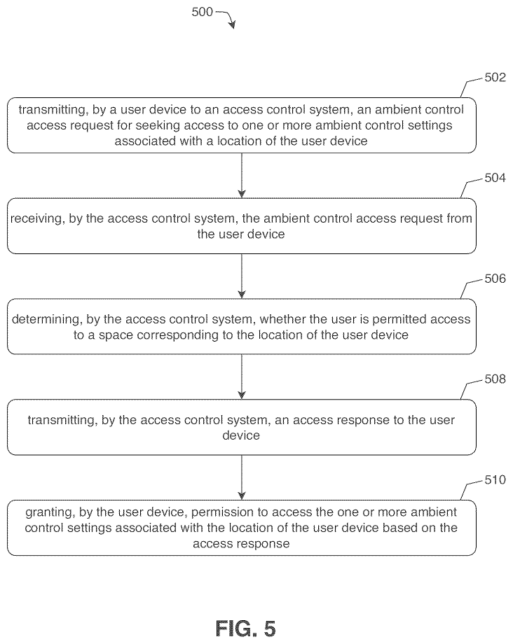

FIG. 5 illustrates a flowchart of a method 500 for granting users access to ambient control settings in a building environment, according to one or more embodiments of the present disclosure. The steps of the method 500, described in connection with the embodiments disclosed herein, may be embodied directly in hardware, in firmware, in a software module executed by the system 102, or in any practical combination thereof.

At step 502, a user device transmits an ambient control access request to an access control system. In an example, a user seeking access to the ambient control settings pertaining floor elements, such as fan, lights, heating, cooling, etc. may use the user device to send the ambient control access request to the access control system. In some embodiments, the request may include the current location of the user device and a user id associated with the user.

In an example, the user device may determine its location by using an indoor positioning technique. Herein, the user device may calculate its location using wireless beacons installed across the building. Particularly, the user device may evaluate signals emitted by the beacons and subsequently determine the user device's position through triangulation techniques. For example, in a conference room equipped with wireless beacons, the user device detects and processes the signal strengths and time delays from the surrounding beacons to determine the user device's location.

In an example, the user device may determine its location by using a Wi-Fi fingerprinting technique. Herein, the user device may scan one or more nearby Wi-Fi access points and compares their signal strengths and identifiers (e.g., MAC addresses) against a pre-configured Wi-Fi fingerprint map stored in the access control system. Using this map, the user device computes its location. For example, in an open workspace, the user device identifies unique access points within its range and resolves its position using one or more pattern-matching algorithms.

In yet another technique, if the user device has GPS capabilities, the user device may determine its geographical coordinates which corresponds to its location using its GPS. In some cases, GPS positioning may be combined with indoor positioning methods for enhanced accuracy. For instance, a user may walk into the building's lobby, where GPS is used initially to determine the location and later refined using Wi-Fi fingerprinting as the user enters a designated indoor space.

Referring to the user id, the user id transmitted in the access request may be an employee id, a guest id, or a temporary access credential. For example, a guest visiting the organization logs in to the building management application using a temporary guest id provided by the front desk. Upon accessing the application, the user selects a menu option to control ambient settings. The user device gathers its location and transmits the ambient control access request, including the location and guest id, to the access control system.

At step 504, the access control system receives the ambient control access request from the user device. In some embodiments, the access control system may include a cloud-based services. In some embodiments, the access control system may include an on-premise server. In some embodiments, the access control system may include both, the cloud-based services and the on-premise server, in case of a hybrid deployment. The access control system may be configured to receive the request from the user device and decode the location details and the user id included therein.

At step 506, the access control system determines whether the user is permitted access to a space corresponding to the location of the user device. In an example, the access control system may query an access control database for making this determination. In an example, the database may include information about the plurality of spaces within the building, including their identifiers and geographical boundaries. The database may further include information about user access permissions, mapping user ids to specific spaces.

In an example, on receiving the query, the system matches the location coordinates from the access request with records in the database to identify the corresponding space. Once the space is identified, the system checks if the user id is listed as having access to that space. For instance, consider a guest who is present in a demarcated cafeteria space. The database record for the cafeteria may include its location, identifier, and a list of user ids (both employees and temporary guests) permitted access. If the guest id is mapped to the cafeteria, the system determines that access is allowed. Alternatively, if an employee attempts to control ambient settings in a restricted executive meeting room, the database may not find their id listed for that space, resulting in a denial of access.

At step 508, the access control system generates and transmits an access response to the user device. The response includes information on whether the user is permitted to access the space and its associated ambient controls. For a positive response, the system includes a flag indicating that access is granted, along with any additional details about the space. For example, the response may contain the name of the space (“Conference Room A”) and a list of available ambient controls (e.g., lighting and HVAC settings). Conversely, for a negative response, the system includes a denial flag, optionally accompanied by an error message or instructions for further action.

At step 510, based on the access response, the user device either grants or denies permission to access the ambient controls. If access is permitted, the user device unlocks the relevant features in the application or website, allowing the user to view and interact with the controls. For instance, consider a case where an employee logged into the building management application requests access to ambient controls for their workspace. The access control system verifies the user's credentials and location, determines that access is permitted, and transmits a positive response. The application then displays a graphical user interface (GUI) listing ambient controls such as, Light brightness and color settings, Fan speed adjustments, Temperature controls for the HVAC system, etc. The employee selects the fan control option, reduces its speed, and confirms the change. The user device generates a control request and forwards it to the building management system, as explained in FIG. 3.

In the case where the access is not permitted, the user device displays an error message on a display of the user device. For instance, consider a case where a guest attempts to access ambient controls for a private meeting room. Since the guest's id is not listed for the meeting room, the access control system denies the request. Accordingly, the application may display an error message: “Access Denied: You do not have permission to modify the settings in this space. Please contact the administrator.” In cases where access is denied, the application may offer additional support options. For instance, the error message could include contact information for technical support or a designated administrator.

In some embodiments, users, such as an administrator of the organization may define one or more spaces on a floor of the building and assign access rights thereto using the system. For instance, the admin may mark a shared printer section on a digital floor plan and may assign one or more doors and user ids to this space. Once configured, employees and guests with mapped ids can control ambient settings, such as turning on/off the printer area lighting in the shared printer section.

In some embodiments, once access is granted to the user, the user may provide user inputs for modifying the ambient settings. For example, on being provided with access to the ambient control settings related to a conference room of the floor, the user may provide a user input to switch on a light in the conference room. Based on the user input, a control request for modifying the ambient setting, i.e., switching on the light, may be routed to a BMS. The BMS receives the control request and implements the change in the ambient settings, as requested by the user in the control request.

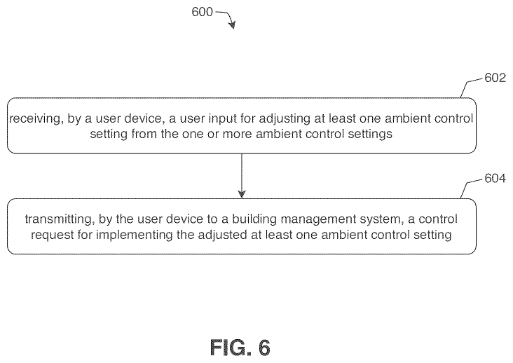

FIG. 6 illustrates a flowchart of a method 600 for adjusting ambient control settings in a building environment, according to one or more embodiments of the present disclosure. The steps of the method 600, described in connection with the embodiments disclosed herein, may be embodied directly in hardware, in firmware, in a software module executed by a user device, or in any practical combination thereof.

At step 602, a user device may receive a user input for adjusting at least one ambient control setting from a set of ambient control settings available to the user. In an example, a user may interact with a graphical user interface (GUI) displayed on the user device to modify a specific ambient setting, such as turning off a light, adjusting the temperature, or reducing the fan speed in a room. The user input may correspond to the desired adjustment, such as a new value or state for the selected control setting.

Upon receiving the user input, the user device processes the input to generate a control request. The control request encapsulates details such as an identifier of the adjusted ambient control setting and the new state or value desired by the user. For instance, if the user wishes to decrease the fan speed, the control request may include the fan's identifier and the updated speed setting specified by the user.

At step 604, the user device transmits the control request to a building management system (BMS) for implementation. In an example, the BMS may include components such as cloud-based services, on-premise systems, or a hybrid deployment of both. The control request is routed through the appropriate system layers for further processing. For instance, the request may be processed to identify the specific end system responsible for managing the ambient control setting in question.

The building management system processes the received control request and communicates with the relevant end system to realize the requested adjustment. For example, if the user has modified a light's brightness level, the end system may control the corresponding electrical component to adjust the light intensity as per the user's input. Similarly, if the adjustment pertains to temperature, the end system may interact with the heating, ventilation, and air conditioning (HVAC) system to implement the change.

In a use case, consider a scenario where a user is working in a shared office space and finds the room's temperature uncomfortable. The user uses a mobile application on their device to adjust the ambient control settings. Upon opening the application, the user navigates to the ambient control interface, which displays available settings such as temperature, lighting, and fan speed.

The user selects the temperature control option and adjusts the desired temperature using a slider on the screen. For example, the user lowers the room temperature from 24° C. to 22° C. This input is processed by the application, and a control request is generated, including the identifier of the thermostat in the room and the new temperature setting.

The user device transmits the control request to the building management system (BMS). The system identifies the relevant thermostat associated with the user's location and routes the control request to the appropriate end system. Upon receiving the request, the BMS implements the temperature adjustment, ensuring the room's temperature is modified to 22° C. as desired by the user.

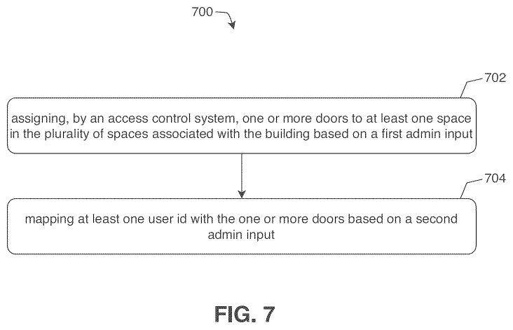

FIG. 7 illustrates a flowchart of a method 700 for assigning doors to spaces and mapping user access in a building environment, according to one or more embodiments of the present disclosure. The steps of the method 700, described in connection with the embodiments disclosed herein, may be embodied directly in hardware, in firmware, in a software module executed by an access control system, or in any practical combination thereof.

At step 702, an access control system may receive a first admin input for assigning one or more doors to at least one space within a building. In an example, an administrator may use a digital interface, such as a web application or mobile application, to designate specific doors associated with a room or open area on a floor plan of the building. The administrator may interact with a visual representation of the building layout to select the doors and associate them with a specific space. For instance, an administrator managing an open workspace may assign multiple entry and exit points to the designated workspace by selecting corresponding doors on the digital map.

Once the doors are assigned, the access control system updates its records to reflect the association between the one or more doors and the specified space. Each space may be uniquely identified within the system to ensure accurate mapping of its associated doors.

At step 704, the access control system receives a second admin input for mapping one or more user identifiers to the assigned doors. In an example, the administrator may input a list of user IDs, such as employee IDs, guest IDs, or other credentials, to grant access to the doors linked to the designated space. This input may be provided through the same digital interface used for assigning the doors. For instance, an administrator managing access to a conference room may map the user IDs of team members who need entry to the room during a meeting.

Upon receiving the second admin input, the access control system updates its access control database to reflect the mapping of user IDs to the one or more doors. The database maintains a comprehensive record of spaces, associated doors, and authorized users, enabling efficient management of access permissions within the building.

In a use case, an administrator may seek to manage access to various spaces on a floor of an office building. Using a building management application, the administrator may demarcate an open space and may virtually assign doors to the demarcated open space. For instance, the administrator selects three doors on the floor plan for the demarcated open space.

Subsequently, the administrator maps user IDs to the assigned doors. For example, the administrator inputs the employee IDs of team members authorized to use the demarcated open space. Additionally, the administrator maps temporary guest IDs for external collaborators who will attend a scheduled meeting in the space.

Once the mapping is complete, the access control system updates its database to reflect the relationships between the conference room, the assigned doors, and the authorized users. As a result of the mapping, the users who are provided access to the demarcated space may seek access to the ambient control settings in the demarcated open space for controlling elements, such as fans, lights, corresponding thereto.

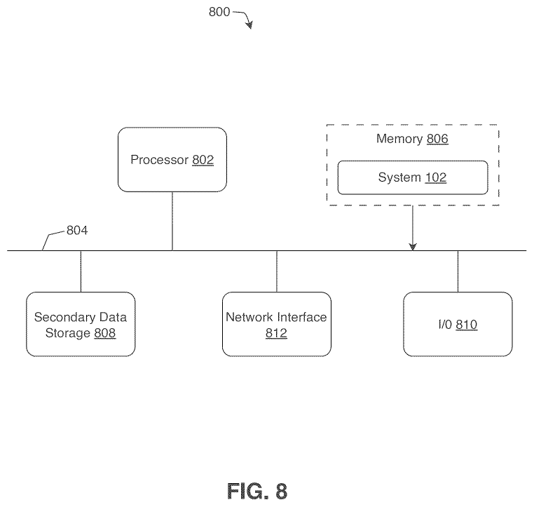

FIG. 8 shows a computer system 800 that may be used with the embodiments and examples described herein. The computer system 800 includes components that may be in a server or another computer system. The computer system 800 may execute, by one or more processors or other hardware processing circuits, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 800 includes at least one processor 802 that may implement or execute machine readable instructions performing some or all of the methods, functions and other processes described herein. Commands and data from the processor 802 are communicated over a communication bus 804. The computer system 800 also includes a main memory 806, such as a random access memory (RAM), where the machine readable instructions and data for the processor 802 may reside during runtime, and a secondary data storage 808, which may be non-volatile and stores machine readable instructions and data. For example, machine readable instructions for the system 102 may reside in the memory 806 during runtime. The memory 806 and secondary data storage 808 are examples of computer readable mediums.

The computer system 800 may include an I/O device 810, such as a keyboard, a mouse, a display, etc. For example, the I/O device 810 includes a display for displaying various graphical user interfaces described herein. The computer system 800 may include a network interface 812 for connecting to a network. Other known electronic components may be added or substituted in the computer system 800.

The present subject matter provides an efficient and secure method and system for granting users access to ambient control settings in a building environment. One of the advantages of the present subject matter is to utilize pre-existing user permissions to determine whether a user should be granted access to the ambient control settings of a particular space within the building. These permissions, which are already defined for access control to various spaces within the building, are repurposed to manage ambient control settings. This eliminates the need to define and manage a separate set of permissions specifically for ambient control settings access.

By leveraging the already established user permissions, the present subject matter reduces the administrative burden typically associated with configuring and managing separate access rights for ambient control settings. This streamlining results in a significant reduction in the resources, time, and effort required for system setup and ongoing maintenance. Administrators no longer need to create duplicative access rights, thereby simplifying the management of user permissions and enabling more efficient operations.

Furthermore, this approach enhances system security by ensuring that access to ambient control settings is inherently tied to the existing access rights of the user. Only those users who are explicitly permitted to access a particular space are granted control over the ambient settings within that space. This integration effectively prevents unauthorized access to the ambient control settings, particularly in sensitive or restricted areas, such as executive offices or high-security zones, where control over environmental settings is critical.

The present subject matter also optimizes resource allocation by reducing the need for additional infrastructure or software components solely dedicated to managing ambient control access. For instance, the present subject matter implements access management within the existing permission framework, thereby simplifying the system architecture and reducing operational costs for organizations deploying the solution.

In summary, the present subject matter provides a robust, secure, and resource-efficient system and method for granting access to ambient control settings in a building environment. By leveraging existing user permissions, the present subject matter not only minimizes administrative overhead and resource consumption but also ensures seamless integration and enhanced security within the overall building access control system.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for granting users access to ambient control settings in a building environment, wherein the method comprises:
transmitting, by a user device to an access control system, an ambient control access request for seeking access to one or more ambient control settings associated with a location of the user device, wherein the access request comprises the location of the user device and a user id associated with a user of the user device;
receiving, by the access control system, the ambient control access request from the user device;
determining, by the access control system, whether the user is permitted access to a space corresponding to the location of the user device based on the location, the user id, and an access control database communicatively coupled to the access control system, wherein the access control database comprises information about a plurality of spaces present in the building and information about a plurality of users who are permitted access to the plurality of spaces;
transmitting, by the access control system, an access response to the user device; and
granting, by the user device, permission to access the one or more ambient control settings associated with the location of the user device based on the access response.

2. The method as claimed in claim 1, wherein the method further comprises, displaying, by the user device, the one or more ambient control settings associated with the location of the user device when the access response is indicative that the user is permitted access to the space corresponding to the location of the user device.

3. The method as claimed in claim 2, wherein the method further comprises:
receiving, by the user device, a user input for adjusting at least one ambient control setting from the one or more ambient control settings; and
transmitting, by the user device to a building management system, a control request for implementing the adjusted at least one ambient control setting.

4. The method as claimed in claim 1, wherein the method further comprises, displaying, by the user device, an error message when the access response is indicative that the user is not permitted access to the space corresponding to the location of the user device.

5. The method as claimed in claim 1, wherein the method further comprises:
assigning, by the access control system, one or more doors to at least one space in the plurality of spaces associated with the building based on a first admin input; and
mapping at least one user id with the one or more doors based on a second admin input.

6. The method as claimed in claim 1, wherein the method further comprises, determining, by the user device, the location of the user device based on at least one of: an indoor location determination technique and a GPS technique.

7. The method as claimed in claim 1, wherein the access control system is one of: a cloud access control system and an on-premise access control system.

8. A system for granting users access to ambient control settings in a building environment, wherein the system comprises:
a user device configured to:
transmit, to an access control system, an ambient control access request for seeking access to one or more ambient control settings associated with a location of the user device, wherein the access request comprises the location of the user device and a user id associated with a user of the user device; and
grant permission to access the one or more ambient control settings associated with the location of the user device based on an access response received from the access control system; and
the access control system communicatively coupled to the user device, wherein the access control system is configured to:
receive the ambient control access request from the user device;
determine whether the user is permitted access to a space corresponding to the location of the user device based on the location, the user id, and an access control database communicatively coupled to the access control system, wherein the access control database comprises information about a plurality of spaces present in the building and information about a plurality of users who are permitted access to the plurality of spaces; and
transmit the access response to the user device.

9. The system as claimed in claim 8, wherein the user device is further configured to:
display the one or more ambient control settings associated with the location of the user device when the access response is indicative that the user is permitted access to the space corresponding to the location of the user device.

10. The system as claimed in claim 9, wherein the system further comprises a building management system, wherein the user device is further configured to:
receive a user input for adjusting at least one ambient control setting from the one or more ambient control settings; and
transmit, to the building management system, a control request for implementing the adjusted at least one ambient control setting.

11. The system as claimed in claim 8, wherein the user device is further configured to:
display an error message when the access response is indicative that the user is not permitted access to the space corresponding to the location of the user device.

12. The system as claimed in claim 8, wherein the access control system is further configured to:
assign one or more doors to at least one space in the plurality of spaces associated with the building based on a first admin input; and
map at least one user id with the one or more doors based on a second admin input.

13. The system as claimed in claim 8, wherein the user device is further configured to:
determine the location of the user device based on at least one of: an indoor location determination technique and a GPS technique.

14. The system as claimed in claim 8, wherein the access control system comprises one or more of: a cloud access control system and an on-premise access control system.

15. A computer-readable medium having computer-executable instructions stored thereon that, when executed by a processing unit, cause the processing unit to execute a method for granting users access to ambient control settings in a building environment, wherein the processing unit is configured to:
transmit an ambient control access request for seeking access to one or more ambient control settings associated with a location of a user device, wherein the access request comprises the location of the user device and a user id associated with a user of the user device;
receive the ambient control access request from a user device;
determine whether the user is permitted access to a space corresponding to the location of the user device based on the location, the user id, and an access control database communicatively coupled to an access control system, wherein the access control database comprises information about a plurality of spaces present in the building and information about a plurality of users who are permitted access to the plurality of spaces;
transmit an access response to the user device; and
grant permission to access the one or more ambient control settings associated with the location of the user device based on the access response.

16. The computer-readable medium as claimed in claim 15, wherein the computer-executable instructions cause the processing unit to:
display the one or more ambient control settings associated with the location of the user device when the access response is indicative that the user is permitted access to the space corresponding to the location of the user device.

17. The computer-readable medium as claimed in claim 16, wherein the computer-executable instructions cause the processing unit to:
receive a user input for adjusting at least one ambient control setting from the one or more ambient control settings; and
transmit a control request for implementing the adjusted at least one ambient control setting.

18. The computer-readable medium as claimed in claim 15, wherein the computer-executable instructions cause the processing unit to:
display an error message when the access response is indicative that the user is not permitted access to the space corresponding to the location of the user device.

19. The computer-readable medium as claimed in claim 15, wherein the computer-executable instructions cause the processing unit to:
assign one or more doors to at least one space in the plurality of spaces associated with the building based on a first admin input; and
map at least one user id with the one or more doors based on a second admin input.

20. The computer-readable medium as claimed in claim 15, wherein the computer-executable instructions cause the processing unit to:
determine the location of the user device based on at least one of: an indoor location determination technique and a GPS technique.
